(19) United States
(12) Patent Application Publication
(10) Pub. No.: US 2024/0135054 A1
(43) Pub. Date: Apr. 25, 2024

(54) ENSEMBLE KALMAN FILTER (EnKF)-BASED METHOD AND SYSTEM FOR REALTIME INVERSION OF HYDRAULIC FRACTURE

(71) Applicant: CHINA UNIVERSITY OF GEOSCIENCES (BEIJING), Beijing (CN)

(72) Inventors: Qian SUN, Beijing (CN); Zhiping LI, Beijing (CN); Fengpeng LAI, Beijing (CN)

(21) Appl. No.: 18/128,685

(22) Filed: Mar. 29, 2023

(30) Foreign Application Priority Data
Oct. 19, 2022 (CN) 202211286097.8

(51) Int. Cl. G06F 30/20; E21B 49/02; G01V 99/00; E21B 43/26; G06F 111/10

(52) U.S. Cl. CPC G06F 30/20; E21B 49/02; G01V 99/005; E21B 43/26; E21B 2200/20; G06F 2111/10

(57) ABSTRACT

An intelligent Ensemble Kalman Filter (EnKF)-based method and system for real-time inversion of hydraulic fractures is provided. The method includes: conducting real-time sampling on mechanical properties of rocks in a reservoir near a fracturing stage to obtain a rock mechanical property sample set; obtaining a hydrofracturing design parameter sample set according to the rock mechanical property sample set; inputting the rock mechanical property sample set and the hydrofracturing design parameter sample set into a fracture propagation-oriented machine learning model to obtain a predicted fracture propagation state; and obtaining, by EnKF, an updated fracture propagation state according to the predicted fracture propagation state and real-time observation data.

### CROSS REFERENCE TO RELATED APPLICATION

This patent application claims the benefit and priority of Chinese Patent Application No. 202211286097.8, filed with the China National Intellectual Property Administration on Oct. 20, 2022, the disclosure of which is incorporated by reference herein in its entirety as part of the present application.

### TECHNICAL FIELD

The present disclosure relates to the field of inversion of hydraulic fracture, in particular to an intelligent Ensemble Kalman Filter (EnKF)-based method and system for real-time inversion of hydraulic fractures.

### BACKGROUND

A multi-stage fracturing technique for horizontal wells is one of the key techniques for the efficient developments of shale oil and gas reservoirs. By means of real-time inversion of fracture propagation and optimization of fracturing design, real-time hydraulic fracture designs are put forward to achieve the purpose of reducing fracturing costs and increasing the production per well. Conventional fracture characterization techniques such as micro-seismic monitoring, potential and low-frequency ultrasonic sensing are costly and unable to quantitatively assess post-fracturing permeability. More importantly, such approaches are not suitable for deep and ultra-deep reservoirs. The well testing analysis estimates the fracture conductivity by deriving an analytical solution of the governing flow equations, and through analyzing the measured pressure data using type curve and straight line analysis. However, such a method is not suitable for analyzing large-scale fracturing of a heterogeneous reservoir due to its oversimplified assumptions in boundary conditions, flow pattern, fracture shape, et al. The finite element, boundary element and discrete element method are widely used numerical techniques to simulate the process of hydraulic fracture propagation. However, these methods demand high computational overhead and long running time, which makes it difficult to carry out real-time analysis. At present, intelligent fracture inversion technologies mainly analyze static data such as production and pressure after the pump is shut down, without making full use of real-time field response data. Meanwhile, due to the gap in the real-time inversion technology, the design of multi-stage fractured horizontal wells ignores the heterogeneity of a reservoir regarding the spatial distribution of physical and mechanical properties, resulting in the poor time efficiency of fracturing parameters design. In view of this, the present disclosure provides an EnKF-based method and system for real-time inversion of hydraulic fractures.

### SUMMARY

An objective of some embodiments in the present disclosure is to provide an EnKF-based method and system for real-time inversion of hydraulic fractures, which combines the EnKF algorithm and the artificial intelligent expert system to solve the problem that it is difficult to conduct both real-time analysis on engineering response parameters of hydrofracturing and accurate inversion of fractures.

In order to achieve the above objective, the present invention provides the following technical solutions:

The present disclosure provides an EnKF-based method for real-time inversion of hydraulic fracture, including:
conducting real-time sampling on mechanical properties of rocks in a reservoir near a fracturing stage to obtain a rock mechanical property sample set at moment k;
setting hydrofracturing design parameters according to each sample in the rock mechanical property sample set at moment k to obtain a hydrofracturing design parameter sample set at moment k;
inputting the rock mechanical property sample set at moment k and the hydrofracturing design parameter sample set at moment k, as an input sample set, into a fracture propagation-oriented machine learning model to obtain a predicted fracture propagation state at moment k+1 for each input sample in the input sample set, where one rock mechanical property sample and one corresponding hydrofracturing design parameter sample constitute one input sample in the input sample set;
obtaining, by EnKF, an updated fracture propagation state at moment k+1 according to the predicted fracture propagation state at moment k+1 and observation data of wellhead pressure and bottomhole pressure during fracturing at moment k+1; and
letting k=k+1, and returning to the step of “inputting the rock mechanical property sample set at moment k and the hydrofracturing design parameter sample set at moment k as an input sample set into a fracture propagation-oriented machine learning model” for repeating above process until the fracturing stage is fractured completely.

Optionally, the mechanical properties of each rock include Young's modulus, Poisson's ratio and compressive strength of the rock.

Optionally, the hydrofracturing design parameters include pump pressure, proppant concentration and liquid injection flow.

Optionally, the predicted fracture propagation state at moment k+1 for each input sample in the input sample set is calculated according to the following formula:

s_{k+1,j}^{f}=M(s_{k,j}^{u},gₖ)+ε_{k+1,j}; j=1,2, . . . ,Ne,

where s_{k+1,j}^{f} represents a predicted fracture propagation state at moment k+1 for a jth input sample; s_{k,j}^{u} represents an updated fracture propagation state at moment k+1 for the jth input sample; ε_{k+1,j} represents a prediction error of a fracture propagation-oriented machine learning model M for the jth input sample; and Ne represents a number of input samples.

Optionally, said obtaining, by EnKF, an updated fracture propagation state at moment k+1 according to the predicted fracture propagation state at moment k+1 and observation data of wellhead pressure and bottomhole pressure during fracturing at moment k+1 specifically includes:
calculating a mean value of all predicted fracture propagation states at moment k+1, and calculating a covariance according to the mean value;
calculating a Kalman gain matrix at moment k+1 according to the covariance; and
calculating the fracture propagation updated state at moment k+1 according to the Kalman gain matrix at moment k+1, the predicted fracture propagation state at moment k+1 and observation data of wellhead pressure and bottomhole pressure during fracturing at moment k+1.

Optionally, the mean value is calculated according to the following formula:

$${\overline{s}}_{k + 1}^{f} = \frac{1}{{N}_{e}} {{\sum }_{j = 1}}^{{N}_{e}} {s}_{k + 1 , j}^{f} ;$$

the covariance is calculated according to the following formula:

$${C}_{k + 1} = \frac{1}{{N}_{e} - 1} {\sum }_{j = 1}^{{N}_{e}} ( {s}_{k + 1 , j}^{f} - {\overline{s}}_{k + 1}^{f} ) {( {s}_{k + 1 , j}^{f} - {\overline{s}}_{k + 1}^{f} )}^{T} ;$$

the Kalman gain matrix is calculated according to the following formula:

Kₖ₊₁=Cₖ₊₁H^{T}(HCₖ₊₁H^{T}+R)⁻¹; and

the updated fracture propagation state is calculated according to the following formula:

s_{k+1,j}^{u}=s_{k+1,j}^{f}+Kₖ₊₁(dₖ₊₁−Hs_{k+1,j}^{f}),

where sₖ₊₁^{-f} represents a mean value; Cₖ₊₁ represents a covariance; Kₖ₊₁ represents a Kalman gain; H represents a transformation matrix; R represents a covariance of errors in observation data at moment k+1; T represents transposition, and dₖ₊₁ represents real-time observation data of wellhead pressure and bottomhole pressure at moment k+1; and s_{k+1,j}^{u} represents an updated fracture propagation state at moment k+1 for the jth input sample.

Optionally, before obtaining, by EnKF, an updated fracture propagation state at moment k+1 according to the predicted fracture propagation state at moment k+1 and observation data of wellhead pressure and bottomhole pressure during fracturing at moment k+1, the method includes:
conducting normality testing on the predicted fracture propagation state at moment k+1 to determine whether the predicted fracture propagation state at moment k+1 conforms to Gaussian distribution;
if yes, calculating the updated fracture propagation state at moment k+1; and
if no, adjusting the predicted fracture propagation state at moment k+1 to Gaussian distribution.

The present invention also provides an EnKF-based system for real-time inversion of hydraulic fractures, including:
a rock mechanical property sample set constructing module, configured to conduct real-time sampling on mechanical properties of rocks in a reservoir near a fracturing stage to obtain a rock mechanical property sample set at moment k;
a hydrofracturing design parameter sample set constructing module, configured to set hydrofracturing design parameters according to each sample in the rock mechanical property sample set at moment k to obtain a hydrofracturing design parameter sample set at moment k;
a prediction module, configured to input the rock mechanical property sample set at moment k and the hydrofracturing design parameter sample set at moment k as an input sample set into a fracture propagation-oriented machine learning model to obtain a predicted fracture propagation state at moment k+1 for each input sample in the input sample set, where one rock mechanical property sample and one corresponding hydrofracturing design parameter sample constitute an input sample in the input sample set;
an update module, configured to obtain, by EnKF, an updated fracture propagation state at moment k+1 according to the predicted fracture propagation state at moment k+1 and observation data of wellhead pressure and bottomhole pressure during fracturing at moment k+1; and
a cyclic module, configured to let k=k+1, and return to the step of “inputting the rock mechanical property sample set at moment k and the hydrofracturing design parameter sample set at moment k as an input sample set into a fracture propagation-oriented machine learning model” for repeating above steps until the fracturing stage is fractured completely.

Optionally, the mechanical properties of each rock include Young's modulus, Poisson's ratio and compressive strength of the rock.

Optionally, the hydrofracturing design parameters include pump pressure, proppant concentration and liquid injection flow.

According to the specific embodiments provided by the present disclosure, the present disclosure provides the following technical effects:

The present disclosure relates to an intelligent Ensemble Kalman Filter (EnKF)-based method and system for real-time inversion of hydraulic fractures. The method includes: conducting real-time sampling on mechanical properties of rocks in a reservoir near a fracturing stage to obtain a rock mechanical property sample set; obtaining a hydrofracturing design parameter sample set according to the rock mechanical property sample set; inputting the rock mechanical property sample set and the hydrofracturing design parameter sample set into a fracture propagation-oriented machine learning model to obtain a predicted fracture propagation state; and obtaining, by EnKF, an updated fracture propagation state according to the predicted fracture propagation state and real-time observation data of wellhead pressure and bottomhole pressure. The real-time inversion of hydraulic fractures is realized by combining the artificial intelligent expert system with an EnKF algorithm and analyzing real-time engineering response parameters in the process of multi-stage fracturing of a horizontal well.

### BRIEF DESCRIPTION OF THE DRAWINGS

To describe the technical solutions in the embodiments of the present disclosure or in the prior art more clearly, the accompanying drawings required for the embodiments are briefly described below. Apparently, the accompanying drawings in the following description show merely some embodiments of the present disclosure, and persons of ordinary skill in the art may still derive other accompanying drawings from these accompanying drawings without creative efforts.

FIG. 1 is a flowchart of an EnKF-based method for real-time inversion of hydraulic fractures according to Embodiment 1 of the present disclosure; and

FIG. 2 is a diagram showing a technical route of the inversion method according to Embodiment 1 of the present disclosure.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

Ensemble Kalman Filter (EnKF for short) is a real-time optimization algorithm suitable for solving nonlinear and multivariable problems. In recent years, EnKF algorithm has been widely used to solve optimization problems such as history fitting in the field of petroleum engineering. By assimilating actual observation data within a certain time stride with predicted results from the model, this method makes it possible to update physical parameters of a reservoir, such as permeability, relative permeability and porosity in real time. With the aid of the EnKF algorithm, Professor Li Daolun et al. successfully fitted parameters of bottomhole pressure of a multi-stage fractured horizontal well, and performed the inversion of key parameters such as horizontal permeability, initial formation pressure and well storage. In view of the experience of applying the EnKF algorithm to history matching, the attempt to use this method to address realtime requirement in petroleum engineering still faces many difficulties. Although the EnKF algorithm improves the operation speed compared with the traditional history fitting technology, it is still necessary to predict the samples in the set in the data processing by using a numerical simulator. Chen et al. pointed out in the literature that the EnKF algorithm spends several hours in processing data within five time strides. When the EnKF algorithm is used to handle data samples following the non-Gaussian distribution, it tends to obtain prediction results that do not accord with engineering practice. Therefore, data transformation is required to process such samples into near-Gaussian distribution and then analyze the same, which increases the computational cost. In addition, the EnKF-based method for inversion of reservoirs is still based on the oversimplified assumptions that ignore the calculation error of a numerical simulator itself. Therefore, how to further improve the operating speed without loss of the computational accuracy is also the key factor to apply EnKF algorithm to real-time inversion of hydraulic fractures.

An objective of some embodiments of the present disclosure is to provide an EnKF-based method and system for real-time inversion of hydraulic fractures, which combines the EnKF algorithm and the artificial intelligent expert system to solve the problem that it is difficult to conduct both real-time analysis on engineering response parameters of hydrofracturing and accurate inversion of fractures. Moreover, real-time inversion is realized, and the efficiency of inversion can be improved without loss of the accuracy of calculation.

To make the above objectives, features, and advantages of the present disclosure clearer and more comprehensible, the present disclosure will be further described in detail below with reference to the accompanying drawings and the specific examples.

### Embodiment 1

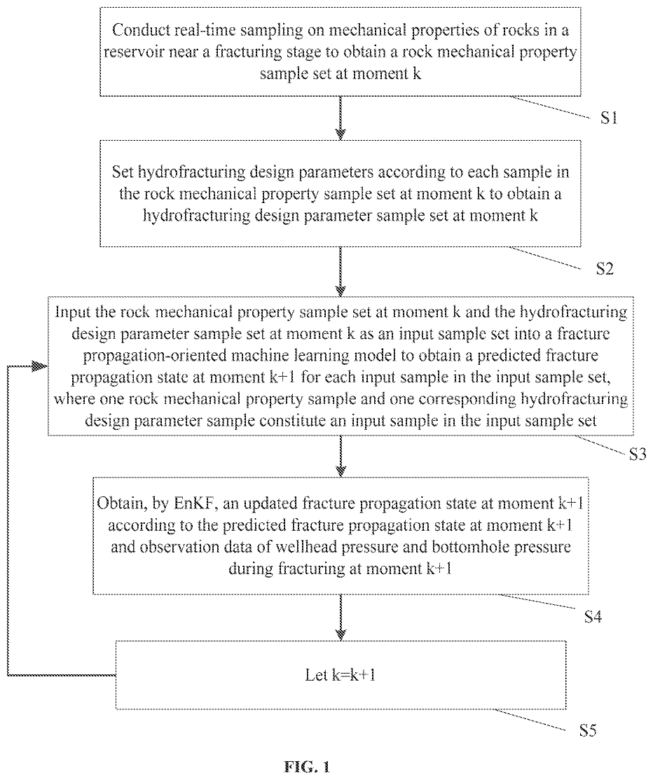

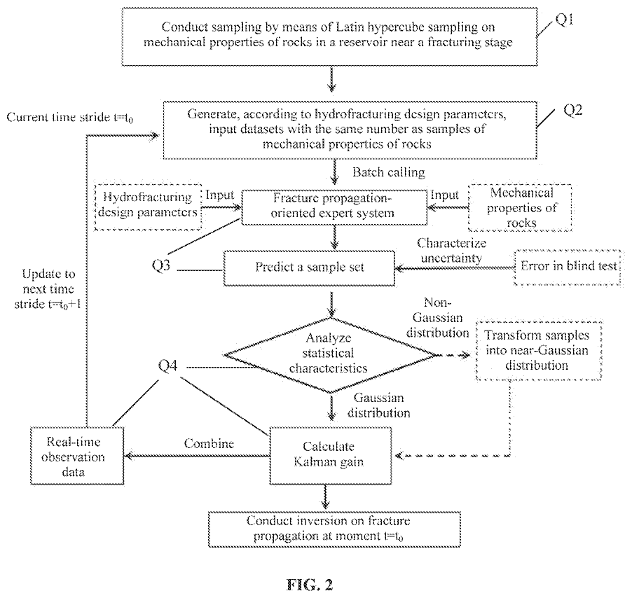

As shown in FIG. 1 and FIG. 2, this embodiment provides an EnKF-based method for real-time inversion of hydraulic fracture. The method includes the following steps S1 to S5.

In step S1, real-time sampling is conducted on mechanical properties of rocks in a reservoir near a fracturing stage to obtain a rock mechanical property sample set at moment k. The mechanical properties of each rock include Young's modulus, Poisson's ratio, compressive strength of rocks, etc.

The mechanical properties (such as Young's modulus, Poisson's ratio, and compressive strength) of the rock in a reservoir near a fracturing stage is predicted, and by means of Latin hypercube sampling (LHS), sampling is conducted within a range of each mechanical property which is in accordance with actual condition, where the number of samples should be not less than 1,000. For example, during sampling, Young's modulus of the rock should be within the range of (a, b). For reference, see step Q1 in FIG. 2.

In step S2, hydrofracturing design parameters are set according to each sample in the rock mechanical property sample set at moment k to obtain a hydrofracturing design parameter sample set at moment k. The hydrofracturing design parameters include pump pressure, proppant concentration and liquid injection flow. For reference, see step Q2 in FIG. 2.

Assuming that in the process of fracturing, the process design parameters do not possess uncertainty, that is, hydrofracturing design parameters are basically unchanged in the fracturing process.

In step S3, the rock mechanical property sample set at moment k and the hydrofracturing design parameter sample set at moment k as an input sample set are inputted into a fracture propagation-oriented machine learning model to obtain a predicted fracture propagation state at moment k+1 for each input sample in the input sample set, where one rock mechanical property sample and one corresponding hydrofracturing design parameter sample constitute one input sample in the input sample set.

The predicted fracture propagation state at moment k+1 for each sample in the input sample sets is calculated according to the following formula:

s_{k+1,j}^{f}=M(s_{k,j}^{u},gₖ)+ε_{k+1,j}; j=1,2, . . . ,Ne,

where s_{k+1,j}^{f} represents a predicted fracture propagation state at moment k+1 for a jth input sample; s_{k,j}^{u} represents an updated (real-time) state of fracture propagation at moment k for the jth input sample, and based on the updated state, the rock mechanical property sample set at moment k is obtained, where the rock mechanical property sample set can be obtained by resampling according to the mechanical properties of rocks in the updated fracture propagation state; gₖ represents a hydrofracturing design parameter sample set at moment k; ε_{k+1,j} represents a prediction error (error in blind test) of a fracture propagation-oriented machine learning model M for the jth input sample at moment k+1; and Ne represents a number of input samples. For reference, see step Q3 in FIG. 2.

The fracture propagation state (including predicted state and updated state) can be described by vector s=[m, r], where m represents the mechanical properties (Young's modulus, Poisson's ratio, and compressive strength) of a fractured formation, r represents dynamic parameters such as bottomhole/wellhead pressure, and the fracture propagation state, wherein the fracture propagation state can be quantitatively characterized by fracture length, fracture width, fracture conductivity and other parameters. That is, s_{k+1,j}^{f}=[m_{k+1,j}^{f},r_{k+1,j}^{f}], s_{k,j}^{u}=[m_{k,j}^{u},r_{k,j}^{u}].

In step S4, an updated fracture propagation state at moment k+1 is obtained by EnKF, according to the predicted fracture propagation state at moment k+1 and observation data of wellhead pressure and bottomhole pressure during fracturing at moment k+1; where the updated fracture propagation state includes an updated state of mechanical properties of rocks, an updated value of bottomhole pressure, an updated value of wellhead pressure, an updated value of fracture length, an updated value of fracture width, an updated value of fracture conductivity, etc.

The EnKF algorithm performs assimilation on the actual observation data within a certain time stride (here, the observation data refers to the bottomhole pressure and wellhead pressure received in real time during the fracturing process) and the model prediction result (here, the model prediction result refers to the bottomhole pressure/wellhead pressure calculated by the expert system model), and updates the fracture propagation state in real time (here, the fracture propagation state can be quantitatively characterized by fracture length, fracture width, fracture conductivity and other parameters), thereby achieving real-time inversion of hydraulic fractures.

In order to achieve data assimilation analysis, EnKF needs to construct a sample set with a certain size (Ne) and following Gaussian distribution, the optimization process by EnKF within a certain time stride of t=[k,k+1] can be divided into a prediction stage and an update stage. In the prediction phase, the method predicts state at the current state by calling the expert system model with reference to the state at the previous time stride. In the update stage, the EnKF algorithm is used to update the current predicted state. For reference, see step Q4 in FIG. 2.

Step S4 specifically includes the following steps (1) to (3).

In step (1), a mean value of predicted fracture propagation states at moment k+1 is calculated, and according to the mean value, a covariance is calculated.

The mean value is calculated according to the following formula:

$${\overline{s}}_{k + 1}^{f} = \frac{1}{{N}_{e}} {{\sum }_{j = 1}}^{{N}_{e}} {s}_{k + 1 , j}^{f} ;$$

The covariance is calculated according to following formula:

$${C}_{k + 1} = \frac{1}{{N}_{e} - 1} {\sum }_{j = 1}^{{N}_{e}} ( {s}_{k + 1 , j}^{f} - {\overline{s}}_{k + 1}^{f} ) {( {s}_{k + 1 , j}^{f} - {\overline{s}}_{k + 1}^{f} )}^{T} .$$

Where Cₖ₊₁ represents a covariance of various samples and various parameters (such as wellhead/bottomhole pressure, fracture length and fracture width) in the predicted fracture propagation state at moment k+1.

In step (2), a Kalman gain matrix at moment k is calculated according to the covariance.

The Kalman gain matrix is calculated according to the following formula:

Kₖ₊₁=Cₖ₊₁H^{T}(HCₖ₊₁HT+R)⁻¹.

In step (3), the updated fracture propagation state at moment k+1 is calculated according to the Kalman gain matrix at moment k+1, the predicted fracture propagation state at moment k+1 and observation data of wellhead pressure and bottomhole pressure (namely, the real-time observation data in FIG. 2) during fracturing at moment k+1.

The updated fracture propagation state is calculated according to the following formula:

s_{k+1,j}^{u}=s_{k+1,j}^{f}+Kₖ₊₁(dₖ₊₁−Hs_{k+1,j}^{f}),

where sₖ₊₁^{-f} represents a mean value; Cₖ₊₁ represents a covariance; Kₖ₊₁ represents a Kalman gain; H represents a transformation matrix, and generally, the transformation matrix is a unit matrix; R represents a covariance of errors in observation data at moment k+1, the EnKF algorithm assumes that any measurement means has a certain error, so this value (in fact the covariance is very small) is added to the calculation formula for the sake of statistical precision; T represents transposition, and dₖ₊₁ represents the real-time observation data at moment k+1, and specifically refers to the data of wellhead pressure and bottomhole pressure at moment k+1; and s_{k+1,j}^{u} represents the updated fracture propagation state of the jth input sample at moment k+1.

The parameters of fracture propagation (fracture length, fracture width, and fracture conductivity) in the updated state s_{k+1,j}^{u} of fracture propagation are real-time inversion results at this moment, and the mechanical properties (such as Young's modulus, Poisson's ratio, and compressive strength) of rocks in the formation are adjusted parameters.

When the EnKF algorithm is used to handle data samples in non-Gaussian distribution, it tends to obtain prediction results that do not accord with engineering practice. As a result, data transformation is required to process such samples into near-Gaussian distribution and then analyze the same, which is equivalent to “Transform samples into near-Gaussian distribution” in the dotted box in FIG. 2. Therefore, before step S4, the method further includes:

A normality testing is conducted on the predicted fracture propagation state at moment k+1 to determine whether the predicted fracture propagation state at moment k+1 conforms to Gaussian distribution.

If it is determined that the predicted fracture propagation state at moment k+1 conforms to Gaussian distribution, the updated fracture propagation state at moment k+1 is calculated.

If it is determined that the predicted fracture propagation state at moment k+1 does not conform to Gaussian distribution, the predicted fracture propagation state at moment k+1 is adjusted to follow Gaussian distribution.

In step S5, Let k=k+1, and the process returns to the step S3 of inputting the rock mechanical property sample set at moment k and the hydrofracturing design parameter sample set at moment k as an input sample set into a fracture propagation-oriented machine learning model, for repeating above steps until the fracturing stage is fractured completely.

In this embodiment, the main working principle is to improve the traditional EnKF algorithm by utilizing high computational efficiency of the “fracture propagation-oriented expert system”, so as to analyze the real-time bottomhole pressure and wellhead pressure in the multi stage fracturing process of a horizontal well and realize real-time inversion of fracture propagation. When the time stride is k, a large number of data samples, such as physical and mechanical properties of a reservoir, simulated wellhead/bottomhole pressure and fracture expansion parameters, are generated by calling the fracture expansion-oriented expert system. By analyzing the statistical characteristics of the samples, the physical and mechanical properties of the reservoir are adjusted when the next moment is k+1, and the real-time inversion of fracture propagation is realized on the basis of fitting model prediction and real data. For samples following non-Gaussian distribution, the samples are updated after being adjusted near-Gaussian distribution by data transformation. When calculating the Kalman increment, the uncertainty of the prediction result is characterized by the error tolerance of the expert system, which eliminates the oversimplified assumption on model prediction errors by the traditional EnKF algorithm.

The traditional EnKF algorithm needs to evaluate the fracture propagation with the aid of numerical simulation method, and due to the limit in the operation cost, it is impossible to achieve real-time inversion on the fracture development. According to the present disclosure, the expert system is used to generate data samples needed by the EnKF algorithm, which not only greatly improves the operation efficiency, but also characterizes the uncertainty of the model prediction through the error tolerance of the expert system. As a result, it is possible to eliminate the excessive assumption of the traditional EnKF algorithm, and realize the real-time inversion on hydraulic fractures. The present disclosure can conduct real-time inversion on hydraulic fractures, so that fracturing parameters may be designed with reference to the real-time hydraulic fractures in practical engineering, and the problem of poor timeliness in fracturing parameter design can be overcome.

By combining the concept of artificial intelligent with hydrofracturing engineering, and through developing a machine learning-based expert system model and an artificial intelligent real-time optimization algorithm, the inversion method according to the present disclosure realizes real-time inversion of fracture propagation by making full use of the real-time field response data during fracturing construction. Therefore, the method has strong field practicability and of a great practical significance in improving the fracturing effect and increasing the output of fracturing wells.

### Embodiment 2

This Embodiment provides an EnKF-based system for real-time inversion of hydraulic fractures, including:
a rock mechanical property sample set constructing module M1, configured to conduct real-time sampling on mechanical properties of rocks in a reservoir near a fracturing stage to obtain a rock mechanical property sample set at moment k; where the mechanical properties of rocks include Young's modulus, Poisson's ratio, and compressive strength of rocks;
a hydrofracturing design parameter sample set constructing module M2, configured to set hydrofracturing design parameters according to each sample in the rock mechanical property sample set at moment k to obtain a hydrofracturing design parameter sample set at moment k; where the hydrofracturing design parameters include pump pressure, proppant concentration and liquid injection flow;
a prediction module M3, configured to input the rock mechanical property sample set at moment k and the hydrofracturing design parameter sample set at moment k as an input sample set into a fracture propagation-oriented machine learning model to obtain a predicted fracture propagation state at moment k+1 for each input sample in the input sample set, where one rock mechanical property sample and one corresponding hydrofracturing design parameter sample constitute an input sample in the input sample set;
an update module M4, configured to obtain, by EnKF, an updated fracture propagation state at moment k+1 according to the predicted fracture propagation state at moment k+1 and observation data of wellhead pressure and bottomhole pressure during fracturing at moment k+1; where the updated fracture propagation state includes an updated state of mechanical properties of rocks, an updated value of bottomhole pressure, an updated value of wellhead pressure, an updated value of fracture length, an updated value of fracture width, and an updated value of fracture conductivity; and
a cyclic module M5, configured to let k=k+1, and return to the step of “inputting the rock mechanical property sample set at moment k and the hydrofracturing design parameter sample set at moment k as an input sample set into a fracture propagation-oriented machine learning model” for repeating above steps until the fracturing stage is fractured completely.

All embodiments in this specification focus on the differences from other embodiments. The same or similar portions of these embodiments may refer to one another. Since the system disclosed in an embodiment corresponds to the method disclosed in another embodiment, the description is relatively simple, and reference can be made to the method description.

Specific examples are used herein to explain the principles and implementations of the present disclosure. The foregoing description of the examples is merely intended to help understand the method of the present disclosure and its core ideas; besides, various modifications may be made by those of ordinary skill in the art to specific implementations and the scope of application in accordance with the ideas of the present disclosure. In conclusion, the content of the present specification shall not be construed as limitations to the present disclosure.

What is claimed is:

1. An Ensemble Kalman Filter (EnKF)-based method for real-time inversion of hydraulic fractures, comprising:
conducting real-time sampling on mechanical properties of rocks in a reservoir near a fracturing stage to obtain a rock mechanical property sample set at moment k;
setting hydrofracturing design parameters according to each sample in the rock mechanical property sample set at moment k to obtain a hydrofracturing design parameter sample set at moment k;
inputting the rock mechanical property sample set at moment k and the hydrofracturing design parameter sample set at moment k as an input sample set into a fracture propagation-oriented machine learning model to obtain a predicted fracture propagation state at moment k+1 for each input sample in the input sample set, wherein one rock mechanical property sample and one corresponding hydrofracturing design parameter sample constitute an input sample in the input sample set;
obtaining, by EnKF, an updated fracture propagation state at moment k+1 according to the predicted fracture propagation state at moment k+1 and observation data of wellhead pressure and bottomhole pressure during fracturing at moment k+1; and
letting k=k+1, and returning to the step of “inputting the rock mechanical property sample set at moment k and the hydrofracturing design parameter sample set at moment k as an input sample set into a fracture propagation-oriented machine learning model” for repeating above steps until the fracturing stage is fractured completely.

2. The method according to claim 1, wherein the mechanical properties of each rock comprise Young's modulus, Poisson's ratio and compressive strength of the rock.

3. The method according to claim 1, wherein the hydrofracturing design parameters comprise pump pressure, proppant concentration and liquid injection flow.

4. The method according to claim 1, wherein the predicted fracture propagation state at moment k+1 for each input sample in the input sample set is calculated according to the following formula:
s_{k+1,j}^{f}=M(s_{k,j}^{u},gₖ)+ε_{k+1,j}; j=1,2, . . . ,Ne,
wherein s_{k+1,j}^{f} represents a predicted fracture propagation state at moment k+1 for a jth input sample; s_{k,j}^{u} represents an updated fracture propagation state at moment k+1 for the jth input sample; ε_{k+1,j} represents a prediction error of a fracture propagation-oriented machine learning model M for the jth input sample; and Ne represents a number of input samples.

5. The method according to claim 4, wherein said obtaining, by EnKF, an updated fracture propagation state at moment k+1 according to the predicted fracture propagation state at moment k+1 and observation data of wellhead pressure and bottomhole pressure during fracturing at moment k+1 specifically comprises:
calculating a mean value of all predicted fracture propagation states at moment k+1, and calculating a covariance according to the mean value;
calculating a Kalman gain matrix at moment k+1 according to the covariance; and
calculating the updated fracture propagation state at moment k+1 according to the Kalman gain matrix at moment k+1, the predicted fracture propagation state at moment k+1 and observation data of wellhead pressure and bottomhole pressure during fracturing at moment k+1.

6. The method according to claim 5, wherein the mean value is calculated according to the following formula:
$${\overline{s}}_{k + 1}^{f} = \frac{1}{{N}_{e}} {{\sum }_{j = 1}}^{{N}_{e}} {s}_{k + 1 , j}^{f} ;$$
the covariance is calculated according to the following formula:
$${C}_{k + 1} = \frac{1}{{N}_{e} - 1} {\sum }_{j = 1}^{{N}_{e}} ( {s}_{k + 1 , j}^{f} - {\overline{s}}_{k + 1}^{f} ) {( {s}_{k + 1 , j}^{f} - {\overline{s}}_{k + 1}^{f} )}^{T} ;$$
the Kalman gain matrix is calculated according to the following formula:
Kₖ₊₁=Cₖ₊₁H^{T}(HCₖ₊₁H^{T}+R)⁻¹; and
the updated fracture propagation state is calculated according to the following formula:
s_{k+1,j}^{u}=s_{k+1,j}^{f}+Kₖ₊₁(dₖ₊₁−Hs_{k+1,j}^{f}),
wherein sₖ₊₁^{-f} represents a mean value; Cₖ₊₁ represents a covariance; Kₖ₊₁ represents a Kalman gain; H represents a transformation matrix; R represents a covariance of errors in observation data at moment k+1; T represents transposition, and dₖ₊₁ represents real-time observation data of wellhead pressure and bottomhole pressure at moment k+1; and s_{k+1,j}^{u} represents an updated fracture propagation state at moment k+1 for the jth input sample.

7. The method according to claim 1, wherein before the obtaining, by EnKF, an updated fracture propagation state at moment k+1 according to the predicted fracture propagation state at moment k+1 and observation data of wellhead pressure and bottomhole pressure during fracturing at moment k+1, the method comprises:
conducting normality testing on the predicted fracture propagation state at moment k+1 to determine whether the predicted fracture propagation state at moment k+1 conforms to Gaussian distribution;
if yes, calculating the updated fracture propagation state at moment k+1; and
if no, adjusting the predicted fracture propagation state at moment k+1 to Gaussian distribution.

8. A system based on the method according to claim 1, comprising:
a rock mechanical property sample set constructing module, configured to conduct real-time sampling on mechanical properties of rocks in a reservoir near a fracturing stage to obtain a rock mechanical property sample set at moment k;
a hydrofracturing design parameter sample set constructing module, configured to set hydrofracturing design parameters according to each sample in the rock mechanical property sample set at moment k to obtain a hydrofracturing design parameter sample set at moment k;
a prediction module, configured to input the rock mechanical property sample set at moment k and the hydrofracturing design parameter sample set at moment k as an input sample set into a fracture propagation-oriented machine learning model to obtain a predicted fracture propagation state at moment k+1 for each input sample in the input sample set, wherein one rock mechanical property sample and one corresponding hydrofracturing design parameter sample constitute an input sample in the input sample set;
an update module, configured to obtain, by EnKF, an updated fracture propagation state at moment k+1 according to the predicted fracture propagation state at moment k+1 and observation data of wellhead pressure and bottomhole pressure during fracturing at moment k+1; and
a cyclic module, configured to let k=k+1, and return to the step of “inputting the rock mechanical property sample set at moment k and the hydrofracturing design parameter sample set at moment k as an input sample set into a fracture propagation-oriented machine learning model” for repeating above steps until the fracturing stage is fractured completely.

9. The system according to claim 8, wherein the mechanical properties of each rock comprise Young's modulus, Poisson's ratio and compressive strength of the rock.

10. The system according to claim 8, wherein the hydrofracturing design parameters comprise pump pressure, proppant concentration and liquid injection flow.

11. The system according to claim 8, wherein the predicted fracture propagation state at moment k+1 for each input sample in the input sample set is calculated according to the following formula:
s_{k+1,j}^{f}=M(s_{k,j}^{u},gₖ)+ε_{k+1,j}; j=1,2, . . . ,Ne,
wherein s_{k+1,j}^{f} represents a predicted fracture propagation state at moment k+1 for a jth input sample; s_{k,j}^{u} represents an updated fracture propagation state at moment k+1 for the jth input sample; ε_{k+1,j} represents a prediction error of a fracture propagation-oriented machine learning model M for the jth input sample; and Ne represents a number of input samples.

12. The system according to claim 11, wherein said obtaining, by EnKF, an updated fracture propagation state at moment k+1 according to the predicted fracture propagation state at moment k+1 and observation data of wellhead pressure and bottomhole pressure during fracturing at moment k+1 specifically comprises:
calculating a mean value of all predicted fracture propagation states at moment k+1, and calculating a covariance according to the mean value;
calculating a Kalman gain matrix at moment k+1 according to the covariance; and
calculating the updated fracture propagation state at moment k+1 according to the Kalman gain matrix at moment k+1, the predicted fracture propagation state at moment k+1 and observation data of wellhead pressure and bottomhole pressure during fracturing at moment k+1.

13. The system according to claim 12, wherein the mean value is calculated according to the following formula:
$${\overline{s}}_{k + 1}^{f} = \frac{1}{{N}_{e}} {{\sum }_{j = 1}}^{{N}_{e}} {s}_{k + 1 , j}^{f} ;$$
the covariance is calculated according to the following formula:
$${C}_{k + 1} = \frac{1}{{N}_{e} - 1} {\sum }_{j = 1}^{{N}_{e}} ( {s}_{k + 1 , j}^{f} - {\overline{s}}_{k + 1}^{f} ) {( {s}_{k + 1 , j}^{f} - {\overline{s}}_{k + 1}^{f} )}^{T} ;$$
the Kalman gain matrix is calculated according to the following formula:
Kₖ₊₁=Cₖ₊₁H^{T}(HCₖ₊₁H^{T}+R)⁻¹; and
the updated fracture propagation state is calculated according to the following formula:
s_{k+1,j}^{u}=s_{k+1,j}^{f}+Kₖ₊₁(dₖ₊₁−Hs_{k+1,j}^{f}),
wherein sₖ₊₁^{-f} represents a mean value; Cₖ₊₁ represents a covariance; Kₖ₊₁ represents a Kalman gain; H represents a transformation matrix; R represents a covariance of errors in observation data at moment k+1; T represents transposition, and dₖ₊₁ represents real-time observation data of wellhead pressure and bottomhole pressure at moment k+1; and s_{k+1,j}^{u} represents an updated fracture propagation state at moment k+1 for the jth input sample.

14. The system according to claim 8, wherein before the obtaining, by EnKF, an updated fracture propagation state at moment k+1 according to the predicted fracture propagation state at moment k+1 and observation data of wellhead pressure and bottomhole pressure during fracturing at moment k+1, the method comprises:
conducting normality testing on the predicted fracture propagation state at moment k+1 to determine whether the predicted fracture propagation state at moment k+1 conforms to Gaussian distribution;
if yes, calculating the updated fracture propagation state at moment k+1; and
if no, adjusting the predicted fracture propagation state at moment k+1 to Gaussian distribution.

15. The system according to claim 8, wherein the mechanical properties of each rock comprise Young's modulus, Poisson's ratio and compressive strength of the rock.

16. The system according to claim 9, wherein the mechanical properties of each rock comprise Young's modulus, Poisson's ratio and compressive strength of the rock.

17. The system according to claim 10, wherein the mechanical properties of each rock comprise Young's modulus, Poisson's ratio and compressive strength of the rock.

18. The system according to claim 11, wherein the mechanical properties of each rock comprise Young's modulus, Poisson's ratio and compressive strength of the rock.

19. The system according to claim 12, wherein the mechanical properties of each rock comprise Young's modulus, Poisson's ratio and compressive strength of the rock.

20. The system according to claim 8, wherein the hydrofracturing design parameters comprise pump pressure, proppant concentration and liquid injection flow.
